(19) United States
(12) Patent Application Publication
(10) Pub. No.: US 2015/0373509 A1
(43) Pub. Date: Dec. 24, 2015

(54) GROUP GAMING PLATFORM FOR MOBILE DEVICES IN PROXIMITY

(71) Applicants: Xiaodong Wang, Saratoga, CA (US); Steve X. Gu, Palo Alto, CA (US); Shangpin Chang, San Jose, CA (US)

(72) Inventors: Xiaodong Wang, Saratoga, CA (US); Steve X. Gu, Palo Alto, CA (US); Shangpin Chang, San Jose, CA (US)

(73) Assignee: Dewmobile, Inc., Grand Cayman (KY)

(21) Appl. No.: 14/514,765

(22) Filed: Oct. 15, 2014

Related U.S. Application Data
(60) Provisional application No. 62/014,148, filed on Jun. 19, 2014.

(51) Int. Cl. H04W 4/08; A63F 13/35; A63F 13/87; H04W 4/00; H04W 76/02

(52) U.S. Cl. CPC H04W 4/08; H04W 4/008; H04W 76/023; A63F 13/87; A63F 13/35; H04W 84/12

(57) ABSTRACT

Apparatus and method are provided for a group gaming platform for mobile devices in proximity. In one novel aspect, a Game Directory Service provides an ad-hoc game list to all registered UEs. A registrar UE collects locally installed games from registered subscriber UEs and updates the list based on trigger events. In another novel aspect, the Executable Distribution Service is provided to expedite the downloading. A game-host UE sends a united resource location of an installer for the group game to all invited UEs together with the invitation message. In another novel aspect, Remote Game Hosting Service enables a passive-client UE to play a group game without installing the game locally. The passive-client UE relays detected sensor readings to a passive-host UE. The passive-host UE uses peer messaging and scene streaming to run the game logic and to stream the scene sequences to one or more passive-client UEs.

### CROSS REFERENCE TO RELATED APPLICATIONS

This application claims priority under 35 U.S.C. §119 from U.S. Provisional Application No. 62/014,148 entitled “GROUP GAMING PLATFORM FOR MOBILE DEVICES IN PROXIMITY,” filed on Jun. 19, 2014, the subject matter of which is incorporated herein by reference.

### TECHNICAL FIELD

The present invention relates generally to networking of wireless devices and, more particularly, methods and apparatus for group gaming platform for mobile devices in proximity.

### BACKGROUND

Mobile social networking enjoys exponential growth in recent years. The popularity of mobile social game, social data sharing has skyrocketed. Group games using wireless smart devices require easy setup, convenient access to a variety of games and a stable wireless connection for game execution. An important prerequisite to provide a more user-friendly mobile group game experience is to have less dependency on the condition of the mobile or wireless network.

Traditional networked games rely on the Internet to provide communication among multiple peer players. A centralized server connected to the Internet handles exchanges of user inputs and game synchronization. Thereby, it requires each participant having Internet access. Such restriction makes calling a group game less feasible, especially at places where Internet access is limited or not available. Further, the long latency of communication over the Internet excludes some games that require more real-time responses. Furthermore, the cost of mobile data consumption for game downloading and peer data sharing for the game is another friction to organize a mobile group game.

The development of peer wireless LAN, which allows a group of mobile devices to share data without requiring Internet or a wireless Access Point (AP), provides solutions to the shortcomings of the traditional networked group game. However, the current mobile devices do not elaborate the support to facilitate group gaming over peer wireless LAN. Further, existing data sharing methods using peer wireless LAN do not optimize the user experience for applications such as real-time group games.

Improvements and enhancements are required to provide more efficient, easy to use and reliable solutions for mobile social game via peer wireless LAN.

### SUMMARY

Apparatus and method are provided for a group gaming platform for mobile devices in proximity. In one novel aspect, a Game Directory Service provides an ad-hoc game list to all registered UEs by a UE in the registrar-host mode. The registrar-host UE collects locally installed games from registered registrar-client UEs. In one embodiment, each UE registers all the games locally installed upon joining the game group. The registrar-host UE, replies with a registration response message, which includes an aggregated list of games of all registered UEs in the peer wireless LAN. The Game Directory Service updates the ad-hoc game list upon detecting predefined triggering events. The ad-hoc game list is updated when a registered UE adds or deletes one or more installed games. The ad-hoc list is also updated when a new UE registers with the game group or when a registered UE leaves the game group. In another embodiment, the Game Directory Service further provides a supplementary game list obtained from an external server. The registrar-host UE submits the local game list to the external server and receives a recommended list of games from the external server. The registrar-host UE updates the game-client UEs with the received recommended list as supplementary choices in addition to the local game list.

In another novel aspect, the Executable Distribution Service is provided to expedite the downloading of the group game and to enhance the user experience. A game-host UE initiates a group game by sending game invitation messages to one or more registered neighbor UEs. In one embodiment, the game-host UE sends one or more redundant united resource locations of an installer for the group game to all invited UEs. In one embodiment, the installer is included in the invitation message for the group game. In another embodiment, the game package is pushed to the invited UEs without the user cognition.

In yet another novel aspect, the Remote Game Hosting Service is provided to enable registered UE in proximity playing the group game without locally installed the game. The Remote Game Hosting Service uses peer messaging and scene streaming in the peer wireless LAN. It allows a UE to participate in the group game without having the game installed locally. The UE, thereby, participates the game in a passive-game-client mode. The game-host UE runs the game logic on behalf of the passive-game-client UE and streams scene sequences to the passive-game-client UE. The passive-game-client UE detects sensor readings and relays these sensor readings to the game-host UE.

### BRIEF DESCRIPTION OF THE DRAWINGS

The accompanying drawings, where like numerals indicate like components, illustrate embodiments of the invention.

FIG. 1 is an exemplary diagram of mobile group games using a peer wireless LAN in accordance with embodiments of the current invention.

FIG. 2 illustrates a simplified block diagram of a UE in accordance with novel aspects of the current invention.

FIG. 3 illustrates an exemplary state transition diagram of a UE in accordance with embodiments of the current invention.

FIG. 4 shows an exemplary message sequence diagram of the UE collecting and updating the game list from registered UEs and from the external server.

FIG. 5 shows an exemplary message sequence diagram for updating the game list for different scenarios in accordance to the current invention.

FIG. 6 shows an exemplary flow diagram of a UE entering a game mode in accordance to embodiments of the current invention.

FIG. 7 shows an exemplary message sequence diagram for a game-host UE in accordance with embodiments of the current invention.

FIG. 8 shows an exemplary message sequence diagram for a game-client UE in accordance with embodiments of the current invention.

FIG. 9 shows an exemplary diagram of messaging for the Remote Game Hosting Service in accordance with embodiments of the current invention.

FIG. 10 is an exemplary flow chart of group-game-host service in a peer wireless LAN in accordance with embodiments of the current invention.

FIG. 11 is an exemplary flow chart of group-game-registrar service in accordance with embodiments of the current invention.

### DETAILED DESCRIPTION

Reference will now be made in detail to some embodiments of the invention, examples of which are illustrated in the accompanying drawings.

To address the limitations of the centralized network-based group games, methods and apparatus are provided to use peer wireless LAN to organize mobile social games. A UE is configured to operate in multiple modes such that no centralized dedicated server is required for the mobile group game. Each participating UE is dynamically adapted to be either a game-registrar or a game-subscriber, and simultaneously either a game-host, a game-client, a single-user game-player, or a not-in-game UE. In one novel aspect, the current invention leverages the peer wireless network created by the participating players in a group game. The peer wireless LAN provides abundant bandwidth, free data stream and dynamically adapted game organization. In another novel aspect, novel remote game execution on a UE and game media streaming from the UE are provided. The methods and apparatus construct a mobile game platform, which greatly minimizes the friction to organize a group game for players who are in proximity.

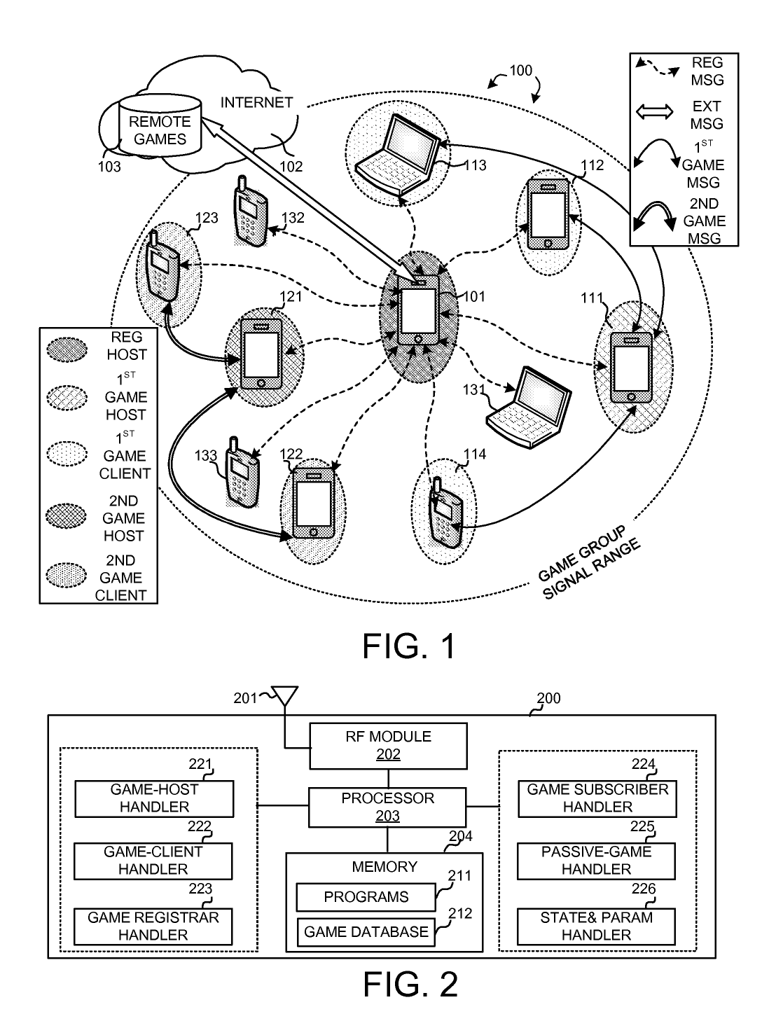

FIG. 1 is an exemplary diagram of mobile group games using a peer wireless LAN 100 in accordance with embodiments of the current invention. In one embodiment, peer wireless LAN 100 is a Wi-Fi network. In another embodiment, peer wireless LAN 100 is a Wi-Fi Direct or a LTE Direct wireless network. Peer wireless LAN 100 includes multiple mobile devices. In establishing a Wi-Fi peer wireless LAN, a UE 101 turns on its AP mode and serves as the soft AP for peer wireless LAN 100. UEs in proximity of UE 101 can join peer wireless LAN 100 by connecting to UE 101. In one novel aspect, UE 101 enters registrar mode upon serving as the soft AP for peer wireless LAN 100. UEs in proximity of UE 101 upon connecting to UE 101 can enter subscriber mode by registering with UE 101 to receive subscriber roll and game list from UE 101. As shown in FIG. 1, UEs 111, 112, 113, 114, 121, 122, 123, 131, 132 and 133 are all connected with UE 101 and registered to receive the Game Directory Service from registrar UE 101. The Game Directory Service is an ad-hoc listing consisting of all games installed on each device registered to the same registrar. In one embodiment, the UE register all the games locally installed upon joining the network. UE 101, the registrar UE, replies with a registration response message, which includes an aggregated list of games of all registered UEs in the peer wireless LAN. Upon leaving the peer wireless LAN, the UE deregister with UE 101 and thereby delists the games locally installed. In another embodiment, when a UE, either a registrar UE or a subscriber UE, installs a new game, the ad-hoc game list is updated to include the newly installed game. Similarly, when a game is uninstalled from a UE, UE 101 is notified. UE 101 updates the ad-hoc game list is accordingly by removing the game from the ad-hoc list. Upon updating of the game list, UE 101 sends game list update to the registered UEs. UE 101, served as the registrar, updates the ad-hoc list game list, which aggregates all locally installed games among the registered UEs. Through the Game Directory Service, each registered UE has access to the list of games maintained by UE 101.

In one novel aspect, the Game Directory Service further provides a supplementary game list obtained from an external game directory. As shown in FIG. 1, UE 101 is also connected to a remote server 103 through the connection to Internet 102. In one embodiment, UE 101 submits the local game list to remote server 103. UE 101 receives a recommended list of games from server 103. UE 101 updates the game-client UEs with the received recommended list as supplementary choices in addition to the local game list.

With the Game Directory Service, the UEs in proximity can have easy access to a list of games to share and play. The supplementary game list further provides the UEs with additional games from remote servers in an easy and efficient way. Upon receiving the local and supplementary game list, the user can choose any game from the list to play. The UEs can choose not to play any game while staying registered with the registrar UE. The UEs can also choose to play single user games. As shown in FIG. 1, UEs 131, 132 and 133 do not participate in any group games while staying registered with UE 101 for the Game Directory Service.

In another novel aspect, UEs in the peer wireless network can join group games using the peer wireless network link without requiring Internet access. FIG. 1 shows an exemplary two group games in peer wireless LAN 100. UE 111 is a game host. UE 112, 113 and 114 join UE 111 for the first group game. UE 111 starts a group game by choosing a game from the game list and initiates the game in the multi-player mode. Upon initiating the group game, UE 111 enters the game-host mode. In the game-host mode, UE 111 chooses one or more neighboring UEs and sends an invitation message to the one or more neighbor UEs. For example, UE 111 may choose to send invitation to all the available UEs in peer wireless LAN 100. Upon receiving the invitation message from UE 111, the UE may decide to join the group game or not. For example, UEs 112, 113, and 114 accept the invitation by replying with an invitation response message. Upon joining the group game, UE 112, 113, and 114 may be able to download the game from a downloading location provided by game-host UE 111. UE 112, 113, and 114 may also choose not to download the game by entering the passive-game-client mode. Game-host UE 111 would stream scene sequences to the passive-game-client UEs to display. The passive-game-client UEs relay sensor readings from the designated hardware to UE 111.

The same game group in peer wireless network 100 can have multiple game hosts for multiple group games. As shown in FIG. 1, UE 121 is another game host. Similarly, UE 121 enters game-host mode upon initiating a group game. UE 121 may choose a few UEs and invite them to the game. For example, UE 121 may invite UE 122, 123, 131 and 111 to its game. UE 131 and 111, in the example, declined the invitation. UE 131 may have engaged in a single player game or does not engage in any game. UE 111 hosts its own group game. In the example, UE 122 and UE 123 accept the invitation and join the group game.

FIG. 2 illustrates a simplified block diagram of a UE 200 in accordance with novel aspects of the current invention. UE 200 comprises an antenna 201, a RF module 202, a processor 203, and a memory 204. Antenna 201 transmits and receives radio signals. RF module 202, coupled with antenna 201, receives RF signals from antenna 201, converts them to baseband signals and sends them to processor 203. RF module 202 also converts received baseband signals from processor 203, converts them to RF signals, and sends out to antenna 201. Processor 203 processes the received baseband signals and invokes different functional modules to perform features in UE 200. Memory 204 stores program instructions and data 211 to control the operations of base station 101. A game database 212 also resides in memory 204.

UE 200 also comprises various function modules including a game-host handler 221, a game-client handler 222, a game-registrar handler 223, a game-subscriber handler 224 and a passive-game handler 225 and a state-and-parameter handler 226. Game-host handler 221 sends game invitation to one or more neighbor UEs to initiate a group game. Game-host handler 221 also makes the group game available to the invited UEs. In one embodiment, game-host handler 221 sends one or more redundant united resource location of an installer for the group game to neighbor UEs. In another embodiment, game-host handler 221 runs game logic for UEs that joins the group game without installing the group game locally. Game-client handler 222 receives an invitation from a game-host UE and joins the group game by accepting the invitation. In one embodiment, game-client handler 222 downloads the group game if the UE does not have the game installed locally. Game-registrar handler 223 collects and shares a list of games with its game-subscribers. In one embodiment, Game-registrar handler 223 further obtains a list of recommended games from an external server and shares the received recommended list with its game-subscribers. Game-subscriber handler 224 connects with a game-registrar UE and receives the game list from it. Game-subscriber handler 224 sends the list of locally installed game to the game-registrar UE and updates its locally installed game upon newly installing or deleting games locally. Passive-game handler 225 receives scene sequences from a game-host UE. Passive-game handler 225 samples host-designated sensor units of the UE and relays the readings to the game-host UE. State and Parameter handler 226 synchronize run-time game states and parameters of neighbor game-client UEs.

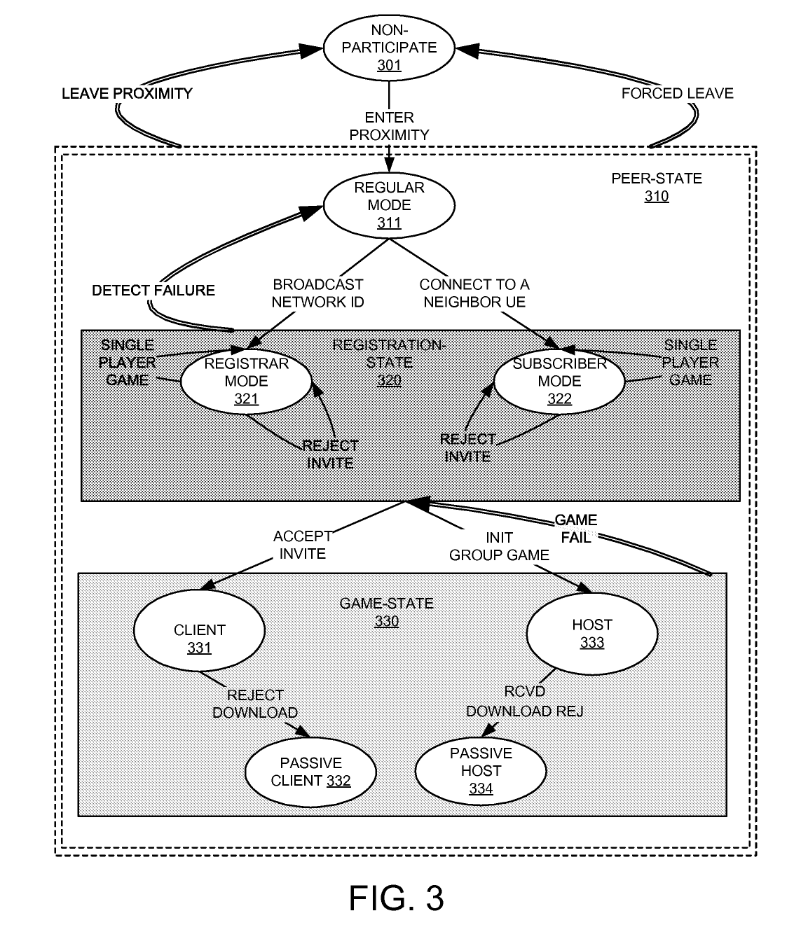

FIG. 3 illustrates an exemplary state transition diagram of a UE in accordance with embodiments of the current invention. The UE maintains two top states, a non-participating state 301, a peer-state 310. Peer-state 310 includes a regular-mode state 311 and two top sub-groups including a registration-state 320, a game-state 330. Registration-state 320 includes two sub-states, a registrar-mode state 321 and a subscriber-mode state 322. Game-state 330 includes four sub-states, a client state 331, a passive-client state 332, a host state 333, and a passive-host state 334.

The UE operates in non-participating state 301 when it does not turn on the game group feature, or when the game group feature is turned on there is no neighbor UE in the proximity detected. In non-participating state 301, the UE operates as a normal UE. Upon turning on the game group feature, the UE enters regular-mode state 311, which is a sub-state of the peer-state 310. In any state of peer-state 310, upon turning off the game group feature, the UE goes back to non-participating state 301. In one embodiment, the UE can force exiting peer-state 310 and go back to non-participating state 301 by detecting one or more predefined triggers. The predefined triggers can be user intervention received from a UI input. The predefined triggers can also be detected UE internal conditions. Similarly, upon detecting one or more predefined registration failure events, the UE in any of the sub-states of registration-state 320 will exit registration-state 320 and goes back to regular-mode state 311 of the peer-state 310. Upon joining or starting a group game, the UE enters the game-state 330. The UE in game-state 330 assumes two roles, a registration role and a game role. Upon detecting a predefined game failure event, the UE exits game-state 330 and goes back registration-state 320.

The top state and sub-state design helps the UE to exit a sub-state upon detecting predefined triggering events. The UE also transition from one state to another following predefined or preconfigured transition algorithms. Therefore, the UE takes different roles in different scenarios.

Upon detecting entering a proximity area with other neighbor UEs, the UE enters regular-mode 311. In regular-mode 311, the UE determines whether to broadcast an encoded network identification to announce being the registrar of a game group for the neighbor UEs. If at regular-mode state 311, the UE determines to be a registrar, the UE transitions to registrar-mode state 321. If at regular-mode state 311, the UE detects a neighbor UE in registrar-mode, the UE may connect to the registrar UE and enters subscriber-mode state 322. In registrar-mode state 321, the UE detects one or more predefined triggering events. The UE stays in registrar-mode state 321 if the UE chooses to play a game in a single user mode or the UE rejects a group game invitation from one or more neighbor UEs. The UE moves to client state 331 upon accepting a group game invitation from a neighbor UE. The UE moves to host state 333 upon initiating a group game. Similarly, in subscriber-mode state 322, the UE detects one or more predefined triggering events. The UE stays in subscriber-mode state 322 if the UE chooses to play a game in a single user mode or the UE rejects a group game invitation from one or more neighbor UEs. The UE moves to host state 333 upon initiating a group game. The UE moves to client state 331 upon accepting a group game invitation from a neighbor UE.

In one novel aspect, the UE can play the group game with the game locally installed, or play the group game in a passive mode without local installation. The UE in game-state 330 transitions to different states accordingly. The UE in state 331 moves to passive-client state 332 upon rejecting downloading the group game when the game is not locally installed. The UE in host state 333 moves to passive-host state 334 upon receiving rejection of downloading the group game from a neighbor UE without the game locally installed.

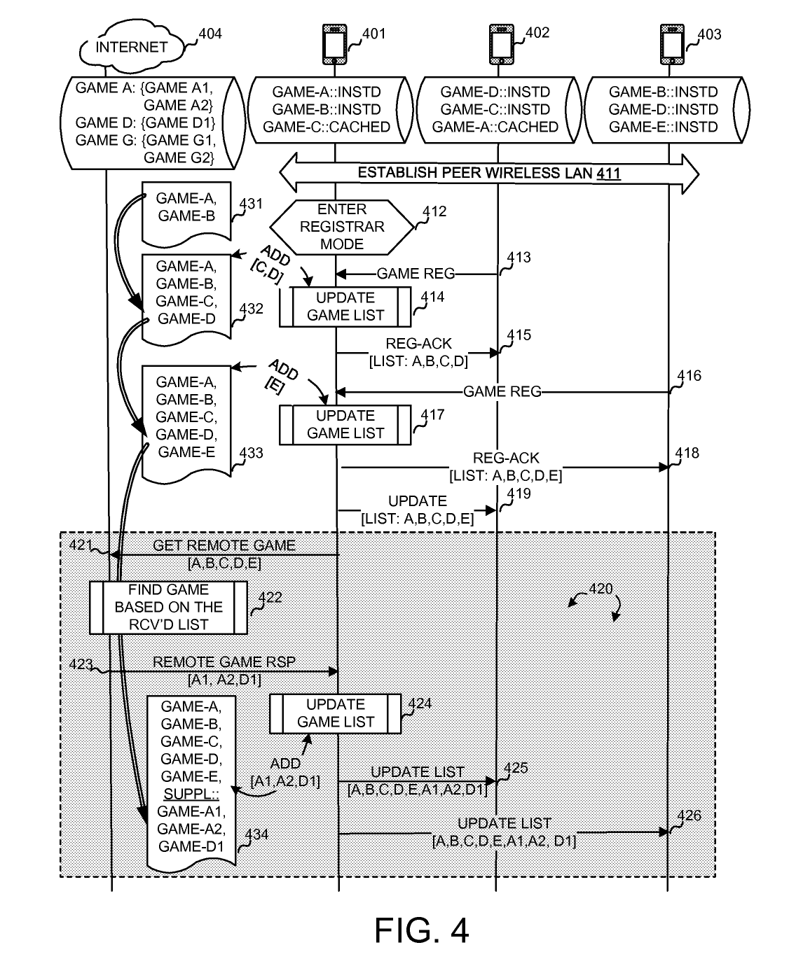

In one novel aspect, the UE in the peer wireless LAN obtains a list of games from a registrar UE. The registrar UE collects games from registered UEs and sends the game list to each registered neighbor UE. The UE can also obtain recommended game list from an external server. FIG. 4 shows an exemplary message sequence diagram of the UE collecting and updating the game list from registering UEs and from the external server. UEs 401, 402 and 403 are in proximity. UE 401 has Game-A and Game-B locally installed and Game-C cached. UE 402 has Game-D and Game-C locally installed and Game-A cached. UE 403 has Game-B, Game-D and Game-E locally installed. A server 404 connected to the Internet has a game database. In one embodiment, the database on server 404 contains information of recommendation list for a given game. As an example, server 404 maintains that Game-A1 and Game-A2 are recommended games for Game-A, Game-D1 is recommended game for Game-D, and Game-G1 and Game-G2 are recommended games for Game-G. At step 411, UE 401, 402 and 403 established peer wireless LAN. At step 412, UE 401 determines to turn into a registrar. UE 401 generates a game list 431 for the peer group, which includes Game-A and Game-B. UE 402 and UE 403 would connect to UE 401 to form the peer wireless LAN. At step 413, UE 402 sends registration message to UE 401. In one embodiment, the registration messages include a list of games that are locally installed. In this example, UE 402 would include Game-D and Game-C in the registration message. Upon receiving the registration message, UE 401 updates the game list at step 414. At step 414, UE 401 adds Game-C and Game-D to the game list and the update list 432 includes games installed on UE 401 and UE 402. At step 415, UE 401 send a registration ACK message to UE 402. In one embodiment, the registration ACK message includes the update game list 432, which includes Game-A, Game-B, Game-C and Game-D. Similarly, at step 416, UE 403 sends registration message to UE 401. In this example, UE 403 would include Game-B, Game-D and Game-E in the registration message. Upon receiving the registration message, UE 401 updates the game list at step 417. Because Game-B and Game-D are already on the game list, at step 417, UE 401 adds Game-E to the game list and generates the updated game list 433, which includes all games of UEs 401, 402 and 403. At step 418, UE 401 sends the registration ACK message to UE 403, which includes the game list 433. Upon updating the game list, UE 401 also sends the updated list to all registered neighbor UEs. At step 419, UE sends update message to UE 402, which includes the games on game list 433. In one embodiment, the update list may include the whole list of the current game list. In another embodiment, the update message may only include the changes to the game list. In this example, update message at step 419 may include only Game-E.

FIG. 4 also shows a procedure 420 for obtaining additional games from an external server. At step 421, UE 401 sends a get-remote-game message through the Internet to external server 404. In one embodiment, the get-remote-game message includes the games on the game list of the locally installed games. In one embodiment, the full list of games on UE 401 is included in the message. In another embodiment, only a subset of games is included in the message. UE 401 may choose the subset of games based on predefined or preconfigured algorithm. The algorithm may also be dynamically changed. Upon receiving the get-remote-game message, external server 404, at step 422, searches for recommended games based on the list of games in the requesting message. In this example, Game-A1 and Game-A2 is found based on Game-A, and Game-D1 is found based on Game-D. At step 423, external server 404 sends remote-game-response message to UE 401, including recommended game list of Game-A1, Game-A2 and Game-D1. Upon receiving the remote-game-response message, UE 401, at step 424 updates its game by adding Game-A1, Game-A2 and Game-D1 as supplementary games to the game list and generates updated game list 434. At step 425, UE 401 sends the updated game list 434 to UE 402. At step 426, UE 401 sends the updated game list 434 to UE 403.

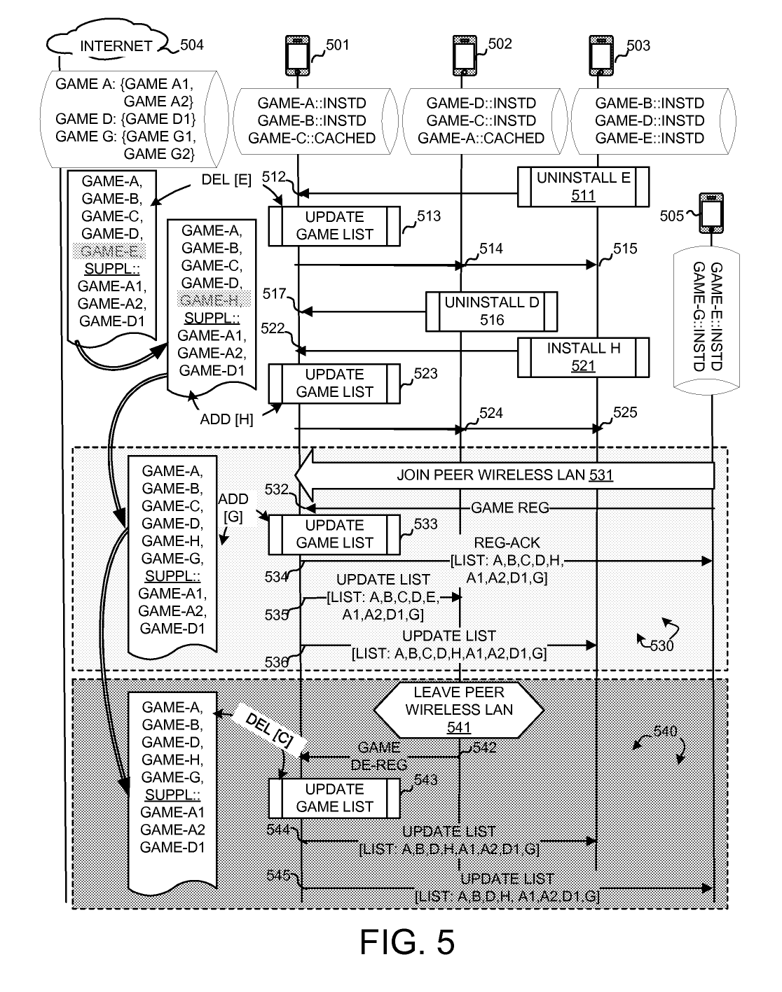

The game list that is maintained by the registrar UE is dynamically updated based on triggering events. In one embodiment, when a registered UE adding or deleting a locally installed game, the game list is updated accordingly. In another embodiment, when a new UE joining the peer group, the game list is updated to include the installed game on the new UE. In yet another embodiment, when a UE leaves the peer group, the game list is update to delete the games locally installed on the leaving UE. FIG. 5 shows an exemplary message sequence diagram for updating the game list for different scenarios in accordance to the current invention. UEs 501, 502 and 503 are in proximity. UE 501 has Game-A and Game-B locally installed and Game-C cached. UE 502 has Game-D and Game-C locally installed and Game-A cached. UE 503 has Game-B, Game-D and Game-E locally installed. A server 504 connected to the internet has a game database. In one embodiment, the database on server 504 contains information of recommendation list for a given game. As an example, server 504 maintains that Game-A1 and Game-A2 are recommended games for Game-A, Game-D1 is recommended game for Game-D, and Game-G1 and Game-G2 are recommended games for Game-G. UE 501 is the registrar UE. UE 501 collects all the locally installed games and generates the game list, which includes Game-A, Game-B, Game-C, Game-D, and Game-E. The game list also includes supplementary game list, which includes Game-A1, Game-A2 and Game-D1.

FIG. 5 illustrates an update procedure when a neighbor deletes a locally installed game. At step 511, UE 503 uninstalled Game-E. In one embodiment, UE 503 sends a message to UE 501 at step 512 informing that Game-E is uninstalled. Upon receiving the message from UE 503, UE 501 checks the game list. In this example, Game-E is only locally installed on UE 503. Therefore, at step 513, UE 501 updates the game list by deleting Game-E from the game list. At step 514, UE 501 sends an update message to UE 502 about the updated game list. At step 515, UE 501 sends an update list to UE 503 about the update game list.

In another scenario when a game is uninstalled from a UE, while the same game is also locally installed on another UE in the peer group, the game is not removed from the game list. At step 516, UE 502 uninstalls Game-D. At step 517, UE 502 sends a message to UE 501 informing UE 501 that Game-D is uninstalled. UE 501 checks the game list. UE 501 determines that another UE, UE 503 still has Game-D installed. Therefore, UE 501 does not delete Game-D from the game list. There is no update to the game list. In one embodiment, the registrar UE maintains a game ID database, where each entry of a game ID is associated with one or more UEs that have the game locally installed.

The registrar UE also updates the game list upon detecting new installation of game on one or more registered UEs. At step 521, UE 503 installs Game-H. At step 522, UE 503 sends a message to UE 501 informing the installation of Game-H. UE 501 checks the game list. UE 501 determines that Game-H is not on the game list. At step 523, UE 501 updates the game list by adding Game-H to the game list. At step 524, UE 501 sends the update message to UE 502 with the updated game list. At step 525, UE 501 sends the update message to UE 503 with the updated game list. In one embodiment, if the registrar UE finds there exists a game on the game list upon detecting a UE's installation of the game, the registrar UE would add on reference entry linking the UE to the game already on the game list. In another embodiment, the update message could be a broadcast message to all the registered UEs.

FIG. 5 further illustrates a procedure 530, which updates the game list upon detecting new UE joining the group. At step 531, a UE 505 joins the peer wireless LAN. UE 505 has Game-E and Game-G locally installed. At step 532, UE 505 sends registration message to UE 501. At step 533, UE 501 checks the game list. UE 501 finds that Game-G is not on the game list. At step 533, UE 501 updates the game list by adding Game-G to the game list. In one embodiment, because Game-E is already on the game list, UE 501 adds a reference entry to the game list linking UE 505 with Game-E. At step 534, UE 501 sends a registration ACK message to UE 505, with the updated game list. At step 535, UE 501 sends update list message to UE 502 with the updated game list. At step 536, UE 501 sends update list message to UE 503 with the updated game list.

FIG. 5 also illustrates a game list update procedure 540 upon a registered UE leaving the peer wireless LAN. At step 541, UE 502 determines to leave the peer wireless LAN. At step 542, UE 502 sends a de-registration message to UE 501. In one embodiment, the de-registration message from UE 502 may include the list of the locally installed game. In another embodiment, the de-registration message may not include any game list. In yet another embodiment, UE 501 may not receive the game de-register message. In the latter scenario, UE 501 may detect the exit of UE 502 based on predefined algorithm. For example, UE 501 may determine that UE 502 has left the peer wireless LAN based on missing heartbeat messages from UE 502. UE 501 upon detecting leaving of UE 502, checks the game list. UE 501 determines that Game-C is only installed on UE 502. Therefore, at step 543 UE 501 updates the game list by deleting Game-C from the game list. At step 544, UE 501 sends update list message to UE 503 with the updated game list. At step 545, UE 501 sends update list message to UE 505 with the updated game list.

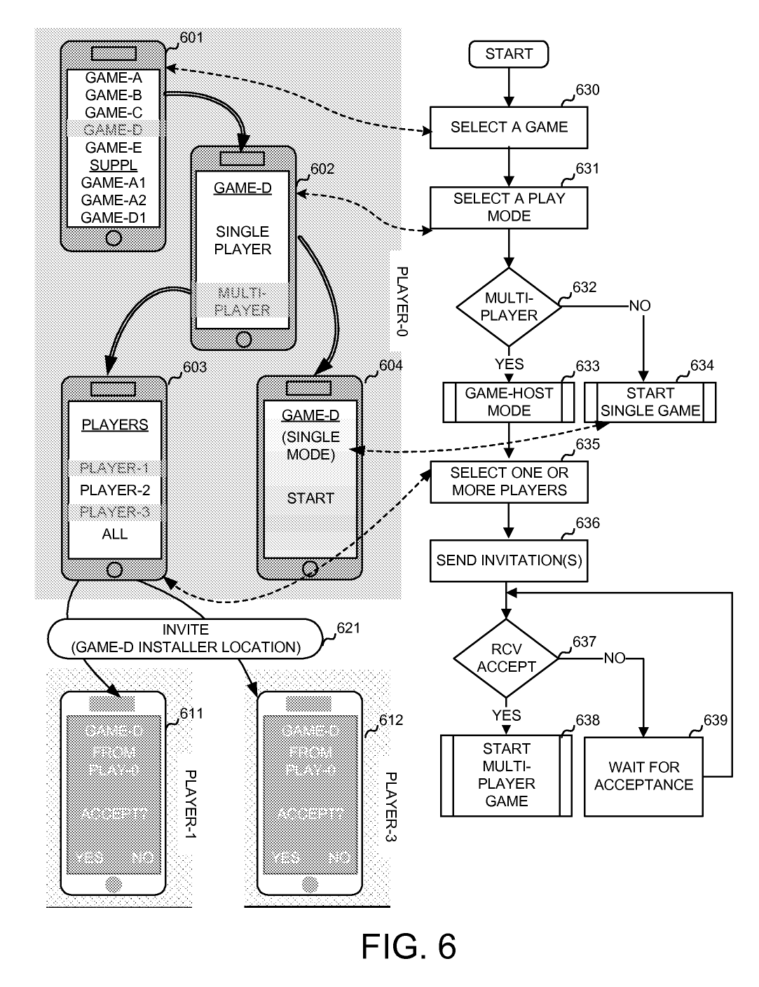

The Game Directory Service provides UEs in the game group a list of aggregated games among the peer group. Upon receiving the game list, the UE can choose to play the game in different mode accordingly. The UE may also choose to download or upgrade games from the game list only without participating in a game. FIG. 6 shows an exemplary flow diagram of a UE entering a game mode in accordance to embodiments of the current invention. At step 630, the UE is prompted select a game from the game list. A simplified screen shot 601 shows the list of games available for the UE. As an example, the UE selects Game-D. Upon selecting a game, the UE moves to step 631 to select a play mode. As a simplified screen shot 602 shows, the UE can select either a single player mode or a multi-player mode. In other embodiments, different choices may be available, such as a two-player option. At step 632, the UE determines whether a multi-player mode is chosen. If step 632 determines a single player mode, the UE moves to step 634 and starts the single player game, as illustrated in a simplified screen shot 604. If the UE determines a multi-player mode, as illustrated in screen shot 602 the UE moves to 633 and enters host mode. The UE then moves to step 635 to select one or more players to invite to group Game-D. In one embodiment, the UE is prompted with a list of all players. In another embodiment, the list of players is a subset of all registered UEs based on a predefined algorithm or preconfigured criteria. As an example as shown in simplified screen shot 603, the UE choses two UEs, player-1 and player-3 to join the game. At step 636, the UE sends invitations to the selected players, player-1 and player-3. In one embodiment, the UEs for player-1 and player-3 would prompt the invitation on their UI as shown in screen shots 611 and 612, respectively. In another embodiment, the UE receiving the invitation may reply without the UI prompt, but instead relies on predefined or preconfigured settings. These reply settings can be user configurable or network configurable.

In one novel aspect, an Executable Distribution Service is provided to expedite group game downloading and enhance user experiences. In one embodiment, the Executable Distribution Service would prompt the UEs that do not have the game installed for the confirmation of downloading the game. In another embodiment, to reduce the delay to start the group game, the Executable Distribution Service figures required duplication and sends over the installation package of the game along with the invitation without the user's cognition. As shown in FIG. 6, in step 621, the UE includes the united resource location of the installer for Game-D in the invitation messages sent to player-1 and player-3. In another embodiment, the installer for Game-D is pushed into the cache memory of player-1 and player-3 without their cognition. Doing so saves the time of downloading the installer once an invited UE accepts the invitation. At step 637, the UE determines whether one or more acceptance messages are received. If step 637 determines that no acceptance message is received, the UE moves step 639 to wait for acceptance message and checks if acceptance message is received. In one embodiment, a wait-for-acceptance timer is started upon sending of the invitation message. If the UE does not receive any acceptance when the timer expired, the UE goes back to either select other players or select another game. In another embodiment, the invited UE may send declination message back to the host UE if the invited UE declines to participate in the game. The host UE, upon receiving declination messages from all UEs being invited, can go back to either select other players or select another game. If step 637 determines that one or more acceptance messages are received, the UE moves to step 638. At step 638, the UE starts the multi-player game.

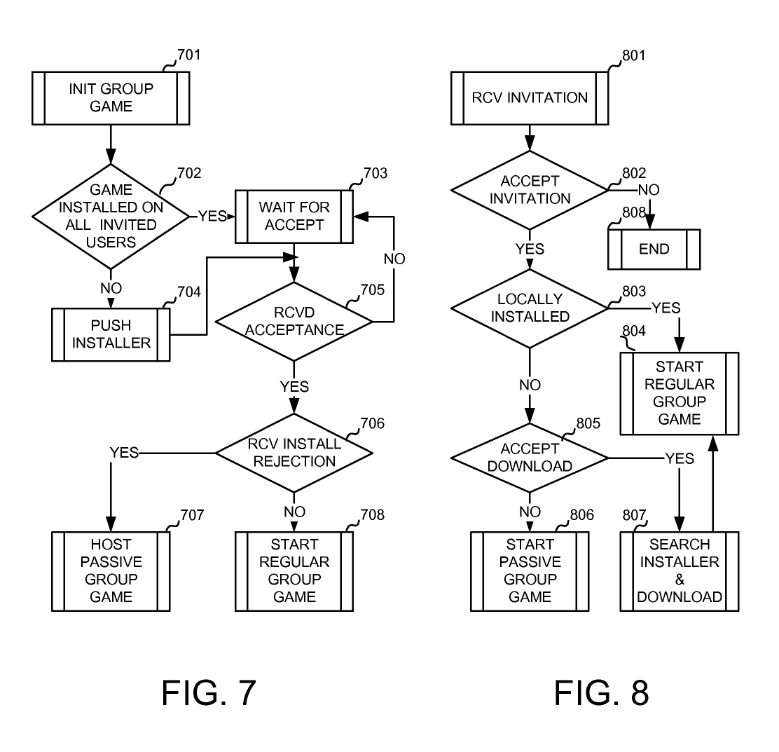

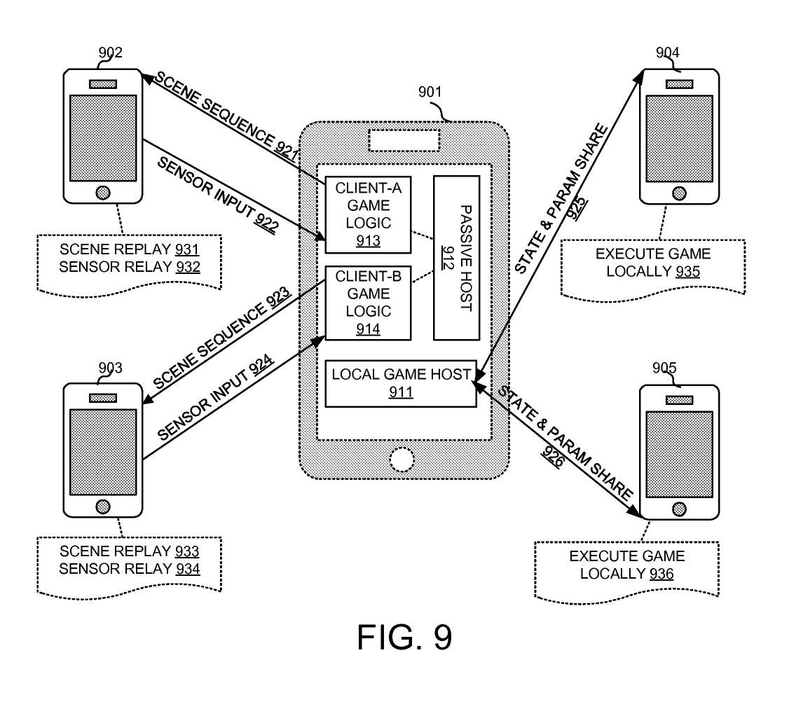

The Executable Distribution Service provides easy and fast game download to enhance user experiences with the group game. Another way to further enhance and expedite the start of group game is through the Remote Game Hosting Service using peer messaging and scene streaming in the peer wireless network. The Remote Game Hosting Service enables a UE participating in a group game without having the game installed locally. The UE, thereby, participates the game in a passive-client mode. The passive-host UE runs the game logic on behalf of the passive-client UE and streams scene sequences to the passive-client UE. The passive-client UE samples sensor readings and relays these sensor readings to the passive-host UE. FIG. 7, FIG. 8 and FIG. 9 illustrate details of the Remote Game Hosting Services.

FIG. 7 shows an exemplary message sequence diagram for a host UE in accordance with embodiments of the current invention. At step 701, the UE initiates the group game. At step 702, the UE determines whether the game is installed on all invited users. If step 702 determines that all the invited users have the game installed, the UE moves to step 703. At step 703, the UE waits for acceptance and moves to step 705. At step 705, the UE determines if the acceptance message is received. If step 705 determines that the acceptance message is not received, it moves back to step 703 and continues waiting for the acceptance message. If step 702 determines that some invited UE does not have the game installed, the UE moves to step 704. At step 704, the UE pushes installer of the group game to the invited users and moves to step 705. If step 705 determines that the acceptance message is received, the UE moves to step 706. At step 706, the UE determines if an installation rejection message is received. In one embodiment, the installer is pushed only to the UEs that do not have the game installed. In another embodiment, the installer is pushed to all invited UEs. In the latter case, the UEs that have the game installed would reply with a positive installation response. If step 706 determines that there is no rejection to the installation, the UE moves step 708. At step 708, the UE start the regular group game. If step 706 determines that one or more UE rejected installation, the UE moves to step 707 and enters the passive-host mode. At step 707, the UE enable Remote Game Host Service and hosts one or more passive-client UEs.

FIG. 8 shows an exemplary message sequence diagram for a client UE in accordance with embodiments of the current invention. At step 801, the UE receives a group game invitation. At step 802, the UE determines whether to accept the invitation. If step 802 determines not to accept the invitation, the UE moves to step 808. At step 808, the UE ends the procedure. In one embodiment, the UE declines the game invitation with an explicit message sent to the host UE. In another embodiment, the UE does not sent a message to the host UE. The host UE, in this case, may rely on a timer to determine if the invited UE declines the invitation silently. If step 802 determines to accept the invitation, the UE moves to step 803. At step 803, the UE determine whether the group game is locally installed. If step 803 determines that game is locally installed, the UE moves to step 804. At step 804, the UE enters the group game in regular mode. If step 803 determines that the game is not locally installed, the UE moves to step 805. At step 805, the UE determines whether to download the game. If step 805 determines to download the game, the UE moves step 807. At step 807, the UE searches for the game installer in cache or downloads the game using the united resource location specified in the invitation. After installing the game, the UE moves to step 804 to start the group game in regular mode. If step 805 determines not to download game, the UE moves to step 806. At step 806, the UE enters passive-client mode and starts the group game in passive group game mode.

FIG. 9 shows an exemplary diagram of messaging for the Remote Game Hosting Service in accordance with embodiments of the current invention. A UE 901, which is the game host UE, is connected with a UE 902, a UE 903, a UE 904 and a UE 905 via a peer wireless LAN. UE 901, 902, 903, 904 and 905 participate in the group game hosted by UE 901. UE 902 and UE 903 do not have the game installed locally. UE 904 and UE 905 have the game installed locally. Host UE 901 can host two types of client UEs. The ones with the game locally installed, such UE 904 and UE 905, are hosted by UE 901 via local game host 911 in UE 901. Host UE 901 and UE 904 exchange game states and parameters at step 925 via the peer wireless LAN. Similarly, Host UE 901 and UE 905 exchange game states and parameters at step 926 via the peer wireless LAN.

Host UE 901 also hosts UEs without the game locally installed, such as UE 902 and UE 903. In one embodiment, each player of the game has the same scene in real time, such as a board game. In another embodiment, each player may have different scenes in real time, such as games that have different viewing angle for different player. The host needs to generate different scenes for different players. Passive host 912 in UE 901 detects passive-client UEs. Upon detecting passive client UEs, passive host 912 in host UE 901 would host the game for the passive client UEs remotely. UE 901 upon detecting passive client 902 would host the game logic for UE 902 via client-A game logic 913. Similarly, UE 901 upon detecting passive client 903 would host the game logic for UE 902 via client-B game logic 914. Client-A game logic 913 streams scene sequences to UE 902 at step 921. UE 902, at step 931, locally displays the scene sequences received from host UE 901. At step 932, UE 902 detects its local sensor reading and relays these readings to host. At step 922, UE 902 sends sensor readings to UE 901. Similarly, Client-B game logic 914 streams scene sequences to UE 903 at step 923. UE 903, at step 933, locally displays the scene sequences received from host UE 901. At step 934, UE 903 detects its local sensor reading and relays these readings to host UE 901. At step 924, UE 903 sends sensor readings to UE 901.

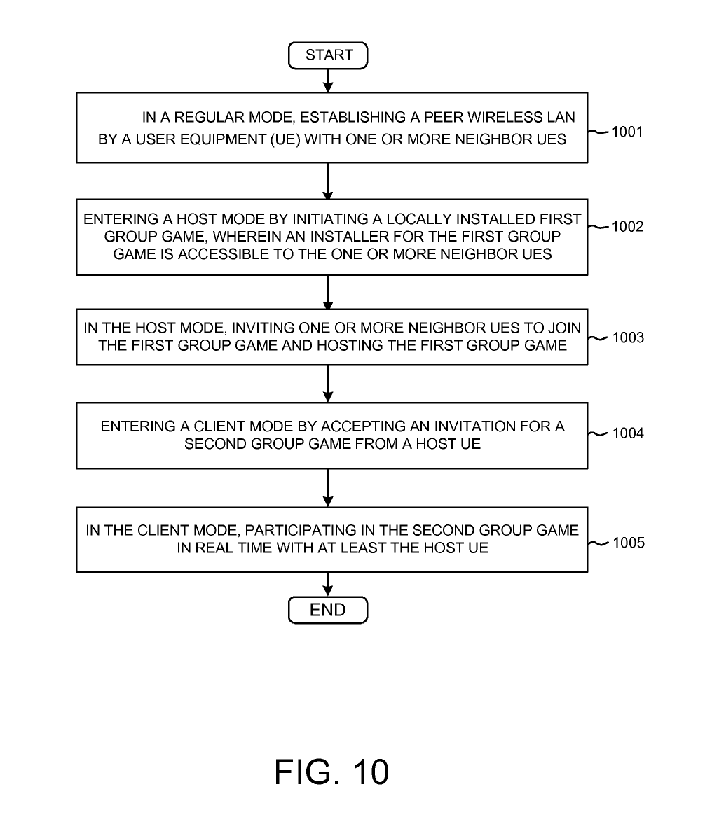

FIG. 10 is an exemplary flow chart of being a game host in a peer wireless LAN in accordance with embodiments of the current invention. At step 1001, the UE in a regular mode, establishes a peer wireless LAN with one or more neighbor UEs. At step 1002, the UE enters a host mode by initiating a locally installed first group game, wherein an installer for the first group game is accessible to the one or more neighbor UEs. At step 1003, the UE, in the host mode, invites one or more neighbor UEs to join the first group game and hosts the first group game. At step 1004, the UE enters a client mode by accepting an invitation for a second group game from a host UE. At step 1005, the UE, in the client mode, participates in the second group game in real time with at least the host UE.

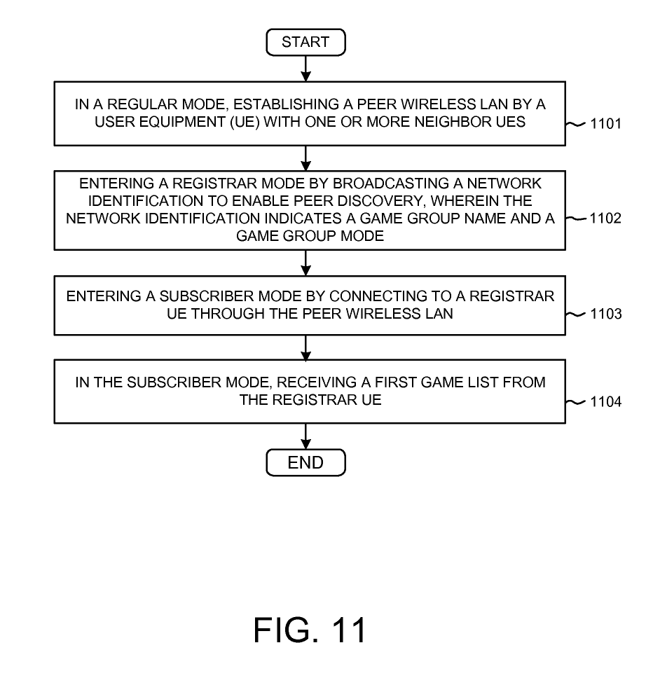

FIG. 11 is an exemplary flow chart of being a game registrar in a peer wireless LAN in accordance with embodiments of the current invention. At step 1101, the UE in a regular mode, establishes a peer wireless LAN with one or more neighbor UEs. At step 1102, the UE enters a registrar mode by broadcasting a network identification to enable peer discovery, wherein the network identification indicates a game group name and a game group mode. In one embodiment, a registrar mode is accomplished by starting a soft access point, wherein the soft access point provides wireless links to the one or more neighbor UEs to be connected in the peer wireless LAN. In another embodiment, a registrar mode is logically defined by being a group host with Wi-Fi Direct or LTE Direct links interconnecting one or more neighbor UEs. At step 1103, the UE enters a subscriber mode by connecting to a registrar UE through the peer wireless LAN. At step 1104, the UE in the subscriber mode, receives a first game list from the registrar UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
in a regular mode, establishing a peer wireless LAN by a user equipment (UE) with one or more neighbor UEs;
entering a host mode by initiating a locally installed first group game, wherein an installer for the first group game is accessible to the one or more neighbor UEs;
in the host mode, inviting one or more neighbor UEs to join the first group game and hosting the first group game;
entering a client mode by accepting an invitation for a second group game from a host UE; and
in the client mode, participating in the second group game in real time with at least the host UE.

2. The method of claim 1, further comprising:
in the host mode, receiving an acceptance from a first neighbor UE and sending a united resource location of an installer for the first group game to the first neighbor UE.

3. The method of claim 2, wherein the united resource location of the installer for the first group game is included in the invitation message.

4. The method of claim 2, wherein the united resource location of the installer for the first group game is only sent to the first neighbor UE if the UE determines the first neighbor UE does not have the first group game installed.

5. The method of claim 1, further comprising:
in the client mode, determining if the second group game is installed on the UE; and
in the client mode, if the second group game is not installed on the UE, downloading an installer for the second group game.

6. The method of claim 5, wherein the installer for the second group game is downloaded without user interaction upon acceptance of the invitation.

7. The method of claim 1, further comprising:
in the client mode, declining installation of the second group game and entering a passive-client mode.

8. The method of claim 7, further comprising:
in the passive-client mode, receiving one or more scene sequences from the host UE;
in the passive-client mode, displaying the one or more scene sequences; and
in the passive-client mode, relaying sensor readings to the host-neighbor UE.

9. The method of claim 1, further comprising:
in the host mode, detecting one or more passive-client mode UEs;
in the host mode, receiving one or more sets of sensor readings from corresponding passive-game mode UEs;
in the host mode, executing one or more sets of game logic on behalf of the one or more passive-client mode UEs based on the corresponding sensor readings; and
in the host mode, streaming one or more sets of scene sequences to the corresponding passive-client mode UEs.

10. The method of claim 1, further comprising:
sharing run-time game states and parameters with one or more neighbor UEs through the peer wireless LAN upon determining that the second group game is locally installed in the client mode.

11. The method of claim 1, wherein the peer wireless LAN is a conventional Wi-Fi wireless network.

12. The method of claim 1, wherein the peer wireless LAN is a Wi-Fi Direct or a LTE Direct wireless network.

13. A method, comprising:
in a regular mode, establishing a peer wireless LAN by a user equipment (UE) with one or more neighbor UEs;
entering a registrar mode by broadcasting a network identification to enable peer discovery, wherein the network identification indicates a game group name and a game group mode;
entering a subscriber mode by connecting to a registrar UE through the peer wireless LAN; and
in the subscriber mode, receiving a first game list from the registrar UE.

14. The method of claim 13, further comprising:
in the registrar mode, collecting one or more game identifiers (IDs) from the one or more neighbor UEs, wherein each game ID is installed on at least one of the neighbor UEs;
in the registrar mode, broadcasting a second game list to the one or more neighbor UEs, wherein the second game list includes the collected game IDs from the registrar UE and the one or more neighbor UEs.

15. The method of claim 14, further comprising:
in the registrar mode, pushing an update of the second game list to the one or more neighbor UEs upon detecting one or more triggering events, wherein the trigger events comprising:
detecting a new UE joining the peer wireless LAN;
detecting an existing subscriber-UE leaving the peer wireless LAN; and
detecting one or more game removal or addition from at least one subscriber-UE in the peer wireless LAN.

16. The method of claim 14, further comprising:
in the registrar mode, sending a get-remote-game message to a remote server, wherein the get-remote-game message includes a list of game IDs in the second game list;
in the registrar mode, receiving a remote-game-response message from the remote server, wherein the remote-game-response message includes a list of recommended game IDs; and
in the registrar mode, updating the second game list with the list of the recommended game IDs.

17. The method of claim 13, further comprising:
in the subscriber mode, generating a displaying game list, wherein the displaying game list includes one or more game IDs from the first game list and locally found installers in the cache, and wherein each game ID is labeled with options comprising: an installation option if the corresponding game is not locally installed, and an upgrade option if a higher version of the corresponding game is available.

18. The method of claim 13, further comprising:
in the subscribe mode, retrieving a game installer based on a game ID, wherein the retrieval involves:
retrieving the game installer of the game ID from a local cache of the UE if the game installer is found in the local cache; otherwise
downloading the game installer of the game ID from a neighbor UE if a united resource location is included in the first game list for the corresponding game ID; otherwise
requesting a united resource location of the game installer of the game ID from the registrar UE.

19. A user equipment (UE), comprising:
a transceiver that transmits and receives radio signals in a peer wireless LAN network connected with one or more neighbor UEs;
a game-host handler that sends an invitation message to initiate a first group game installed on the UE and makes the first group game available to the one or more neighbor UEs in the peer wireless LAN network;
a game-client handler that joins a second group game by accepting an invitation from a neighbor game-host UE;
a game-registrar handler that shares a first list of game with the one or more neighbor UEs; and
a game-subscriber handler that receives a second list of game from a neighbor game-registrar UE.

20. The UE of claim 19, further comprising:
a passive-client handler, wherein the passive-client handler receives one or more scene sequences from a host UE, displays the one or more scene sequences, and relays sensor readings to the host UE.

21. The UE of claim 17, further comprising:
a passive-host handler, wherein the passive-host handler receives one or more sensor readings from one or more passive-client UEs, executing one or more sets of game logic on behalf of each of the corresponding one or more passive-clients UEs based on the corresponding sensor readings, and streams one or more sets of scene sequences to the corresponding passive-client UEs.
